(19) United States
(12) Patent Application Publication
(10) Pub. No.: US 2009/0244793 A1
(43) Pub. Date: Oct. 1, 2009

(54) MAGNETIC TRANSFER METHOD AND MASTER MANUFACTURING METHOD

(75) Inventor: Sumio Kuroda, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/334,081

(22) Filed: Dec. 12, 2008

(30) Foreign Application Priority Data
Mar. 31, 2008 (JP) 2008-092644

(51) Int. Cl. G11B 5/127

(52) U.S. Cl. 360/328

(57) ABSTRACT

A magnetic transfer method includes arranging a magnetic transfer master so as to cause a surface of the magnetic transfer master to be in proximity to or in contact with a vertical magnetic recording medium. The magnetic transfer master has on the surface thereof a concave-convex pattern representing information. A top surface of a convex portion of the concave-convex pattern is divided by a plurality of projecting threads lined up and extending at an interval shorter than a shortest pattern length of the concave-convex pattern. The magnetic transfer method includes applying a magnetic field to the magnetic transfer master in a direction along the surface and intersecting the projecting threads.

### CROSS-REFERENCE TO RELATED APPLICATION

This application is based upon and claims the benefit of priority of the prior Japanese Patent Application No. 2008-092644, filed on Mar. 31, 2008, the entire contents of which are incorporated herein by reference.

### FIELD

The embodiments discussed herein are directed to a magnetic transfer method for transferring information onto a vertical magnetic recording medium as a magnetic pattern, a magnetic transfer master used for a magnetic transfer, a master manufacturing method for manufacturing a magnetic transfer master, and an information reproduction apparatus for reproducing information from the vertical magnetic recording medium having the information transferred thereon with the magnetic transfer.

### BACKGROUND

A hard disk drive (HDD) serving as a large-capacity information storage apparatus incorporated into a personal computer, a portable music terminal, and the like is prevalent. The HDD has a magnetic disk as a storage medium for storing information. In recent years, as the capacity of the HDD becomes larger, the mainstream recording type has been shifted from a conventional horizontal (in-surface) magnetic type to a vertical magnetic type.

A magnetic disk of the HDD has many circular tracks, and information is stored along the tracks. The track is divided into multiple sectors. At the head of each sector, servo information is written as a magnetic pattern to control a magnetic head to read information from and write information to the sector. At a portion subsequent to the head of the sector having the servo information written thereon, the magnetic head writes arbitrary information, which should be stored by an information storage apparatus for an intended purpose, as a magnetic pattern. The arbitrary information is also referred to as user information in the sense that it is information that a user of the information storage apparatus desires to record.

The servo information is information written by a manufacturer prior to shipping the HDD. The servo information is usually written with an apparatus called STW (Servo Track Writer). However, as the amount of the servo information increases along with the increase of the capacity of the HDD, it has been proposed to write the servo information with a magnetic transfer to improve productivity. The magnetic transfer is performed by preparing a master disk (a magnetic transfer master) having recorded thereon a concave-convex pattern corresponding to the magnetic pattern to be recorded as the servo information and applying a recording magnetic field while the master disk is in contact with the magnetic disk, so that information of the concave-convex pattern is transferred to the magnetic disk as the magnetic pattern. The master disk (the magnetic transfer master) is prepared by making a fine concave-convex pattern on a substrate for the master disk and forming a magnetic film thereon.

As a magnetic transfer method for performing the magnetic transfer to the vertical magnetic recording medium, there exists a vertical application method (for example, see Japanese Laid-open Patent Publication No. 2006-73050) for applying the recording magnetic field to the vertical magnetic recording medium in a direction perpendicular to the surface thereof and a horizontal application method for applying the recording magnetic field to the vertical magnetic recording medium along the surface thereof (horizontally). These methods will be hereinafter described with reference to figures.

FIG. 1 is a schematic diagram of the vertical application method.

In the vertical application method, prior to recording the servo information, a uniform magnetic field is applied to a vertical magnetic recording medium 2, so that all over the surface of the vertical magnetic recording medium 2 is initialized, i.e., magnetized in one direction (not illustrated). In an example illustrated in FIG. 1, it is assumed that the vertical magnetic recording medium 2 is initialized in a downward direction of FIG. 1. A master disk 1 having a concave-convex pattern corresponding to the servo information is brought into close contact with the vertical magnetic recording medium 2, and a recording magnetic field is applied in a direction opposite to the initialization direction. A magnetic flux 3 of this recording magnetic field is concentrated on convex portions of the master disk 1, and accordingly, a magnetization of the vertical magnetic recording medium 2 is reversed at portions in contact with these convex portions. Among two magnetizations 2a, 2b as illustrated in FIG. 1, the magnetizations 2a in a downward direction of FIG. 1 are magnetizations in the initialization direction, whereas the magnetizations 2b in an upward direction of FIG. 1 are magnetizations whose direction is reversed by the recording magnetic field.

A reversal pattern of these magnetizations 2a, 2b is the same as a reversal pattern of the concaves and the convexes on the master disk 1. When a magnetic head having a width in a depth direction of FIG. 1 reads the magnetic pattern of these magnetizations 2a, 2b toward a right side of FIG. 1, a read signal 4 becomes a signal having a rectangular waveform as illustrated in a lower row of FIG. 1. A signal reversal pattern of this read signal 4 is the same as the reversal pattern of the magnetization of the magnetic pattern.

FIG. 2 is a schematic diagram of the horizontal application method.

The horizontal application method does not need the initialization. The master disk 1 having the concave-convex pattern corresponding to the servo information is brought into close contact with the vertical magnetic recording medium 2, and the recording magnetic field is applied in a direction along the surface of the master disk 1 and the vertical magnetic recording medium 2 (i.e., a so-called horizontal direction). A magnetic flux 5 of this recording magnetic field enters into the vertical magnetic recording medium 2 from the master disk 1 at an edge (a rising edge) of a convex portion of the master disk 1, passes through the vertical magnetic recording medium 2, exits the vertical magnetic recording medium 2 at a subsequent edge (a falling edge) to return to the master disk 1, and repeats this cycle. At a portion where the magnetic flux 5 enters or exits the vertical magnetic recording medium 2, there exists a vertical magnetic flux component (a vertical component) with respect to the surface of the vertical magnetic recording medium 2. Thus, directions of the magnetizations 2a, 2b can be determined from the vertical component. In an example illustrated in FIG. 2, the magnetization 2b at the rising edge is aligned in the upward direction of FIG. 2, whereas the magnetization 2a at the falling edge is aligned in the downward direction of FIG. 2. In portions between the edges of the master disk 1, there does not exist the vertical component of the magnetic flux 5. In these portions, the directions of the magnetizations 2a, 2b of the vertical magnetic recording medium 2 are temporarily aligned in a direction along the magnetic flux 5 while the recording magnetic field exists. However, when the recording magnetic field disappears, the directions of the magnetizations 2a, 2b become a random mixture of the upward direction and the downward direction.

When the magnetic head having the width in the depth direction of FIG. 2 reads such magnetic pattern toward a right side of FIG. 2, a read signal 6 becomes a signal having a spike-like waveform as illustrated in a lower row of FIG. 2 because at the portion where the directions of the magnetizations 2a, 2b are random, the magnetizations in a core width of a reproduction head are averaged and thereby become substantially zero. The read signal 6 has a waveform equivalent to a waveform obtained by differentiating the read signal 4 as illustrated in the lower row of FIG. 1.

In the vertical application method, a magnetization reversal does not occur in a case where the recording magnetic field is weak. In a case where the recording magnetic field is too strong, the magnetic flux leaks out of the convex portions of the master disk 1 toward the concave portions, and the magnetization reversal area extends beyond an intended area. That is, in the vertical application method, there exists an optimal point for the strength of the recording magnetic field, and furthermore, a margin is small. In addition, among the servo information, the concave-convex pattern representing address information for distinguishing the tracks is an uneven pattern having no continuity between adjacent tracks, and accordingly, in portions where this address information is recorded, there exists a problem that an offset tends to become too large between a concave-convex reversal position on the master disk 1 and a magnetic reversal position (namely, a position of a magnetic wall) on the vertical magnetic recording medium 2 to result in an especially small margin for the strength of the recording magnetic field.

On the other hand, in the horizontal application method, a magnetization reversal does not occur in a case where the recording magnetic field is too weak. The horizontal application method has an advantage that a margin for the strength of the recording magnetic field is greatly larger than the vertical application method because as long as the recording magnetic field is strong, the magnetic flux passes through non-edge portions of the master disk 1 to raise no problem. In addition, the horizontal application method has an advantage that the magnetizations 2a, 2b whose directions are aligned can be lined up substantially precisely at positions of the edges of the master disk 1.

Among the user information and the servo information as described above, correction information for correcting a control of the magnetic head in a reading processing of the user information is recorded onto the medium with the magnetic head, and the magnetic pattern recorded with the magnetic head becomes a magnetic pattern from which a read signal can be obtained that is in a rectangular waveform similar to the rectangular waveform in the lower row of FIG. 1. Thus, there exists a problem that read channels for processing read signals and reproducing information have a low degree of compatibility between the magnetic pattern obtained from the horizontal application type magnetic transfer and the magnetic pattern recorded with the magnetic head, and thus, multiple systems of read channels are required.

### SUMMARY

According to an aspect of the invention, a magnetic transfer method includes:

arranging a magnetic transfer master so as to cause a surface of the magnetic transfer master to be in proximity to or in contact with a vertical magnetic recording medium, the magnetic transfer master having on the surface thereof a concave-convex pattern representing information, a top surface of a convex portion of the concave-convex pattern being divided by a plurality of projecting threads lined up and extending at an interval shorter than a shortest pattern length of the concave-convex pattern; and

applying a magnetic field to the magnetic transfer master in a direction along the surface and intersecting the projecting threads.

According to another aspect of the invention, a master manufacturing method is a method for manufacturing a magnetic transfer master having on a surface thereof a concave-convex pattern representing information, the magnetic transfer master transferring the information represented by the concave-convex pattern onto a magnetic recording medium as a magnetic pattern by causing the surface to be in proximity to or in contact with the vertical magnetic recording medium with an application of a magnetic field, the master manufacturing method including:

forming the concave-convex pattern on a substrate that is to be a basis of the magnetic transfer master; and

before or after the pattern formation, dividing a surface of the substrate into a plurality of projecting threads lined up and extending at an interval shorter than a shortest pattern length of the concave-convex pattern, by forming a plurality of grooves on all over the surface with a stencil mask, the grooves extending in a direction intersecting a direction of the magnetic field.

Objects and advantages of the embodiments will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a schematic diagram of a vertical application method;

FIG. 2 is a schematic diagram of a horizontal application method;

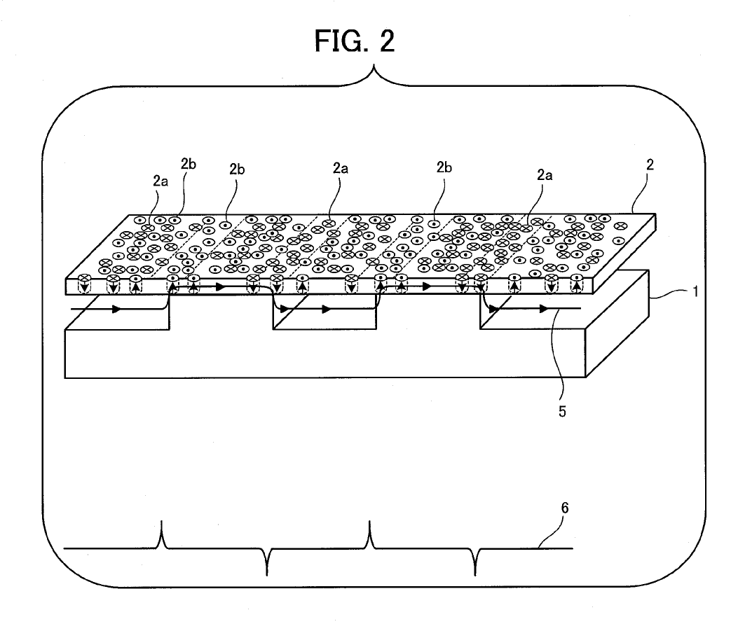

FIG. 3 is a figure illustrating a specific embodiment corresponding to an information reproduction apparatus and an information storage apparatus in a basic form;

FIG. 4 is a figure illustrating a servo pattern on a magnetic disk;

FIG. 5 is a figure illustrating control information representing the servo pattern;

FIG. 6 is a figure illustrating a pattern shape of a so-called staggered pattern;

FIG. 7 is an overall view of a magnetic transfer master used for a magnetic transfer;

FIG. 8 is an enlarged view of a concave-convex pattern formed on a pattern formation area on the magnetic transfer master;

FIGS. 9A and 9B are explanatory diagrams describing a magnetic transfer method for transferring the concave-convex pattern of the magnetic transfer master onto the magnetic disk;

FIG. 10 is a figure illustrating a magnetization state formed on the magnetic disk;

FIG. 11 is a figure illustrating a read signal obtained by causing a magnetic head to read a magnetic pattern from the magnetic disk;

FIG. 12 is a functional block diagram of a reproduction processing circuit in a control circuit;

FIGS. 13A and 13B are figures illustrating a structure of a prefilter;

FIG. 14 is a figure illustrating how a peak hold circuit deforms a signal waveform;

FIG. 15 is a figure illustrating a manufacturing method for the magnetic transfer master;

FIG. 16 is a figure illustrating an electron beam lithography apparatus;

FIG. 17 is a figure illustrating a structure of the magnetic transfer master according to the second embodiment;

FIG. 18 is a figure illustrating a manufacturing method for the magnetic transfer master according to the second embodiment;

FIG. 19 is a figure illustrating a stencil mask;

FIG. 20 is a figure illustrating a structure of a magnetic transfer master according to the third embodiment;

FIG. 21 is a figure illustrating a manufacturing method for the magnetic transfer master according to the third embodiment; and

FIG. 22 is a table indicating whether a demodulation can be performed when the number of formed grooves is changed.

### DESCRIPTION OF EMBODIMENTS

Specific embodiments will be hereinafter described with reference to the figures.

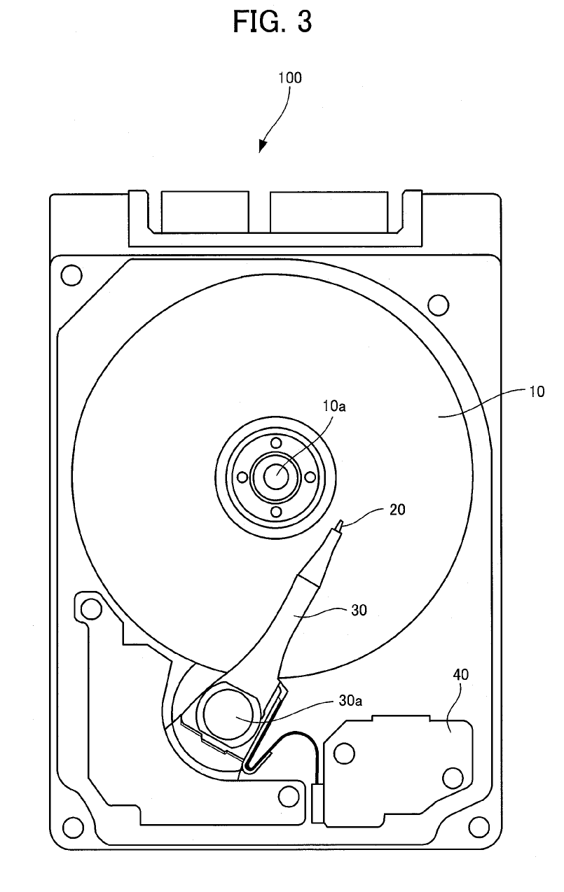

FIG. 3 is a figure illustrating a specific embodiment of each of an information reproduction apparatus and an information storage apparatus.

FIG. 3 illustrates a hard disk apparatus 100, which is the embodiment of each of the information reproduction apparatus and the information storage apparatus.

The hard disk apparatus 100 as illustrated in FIG. 3 is incorporated into a host apparatus such as a personal computer to be used as an information storing means of the host apparatus.

The hard disk apparatus 100 is provided with multiple magnetic disks 10, i.e., so-called vertical magnetic recording media, that are overlapping one another in a depth direction of FIG. 3. The magnetic disks 10 record information in a magnetic pattern magnetized in a direction perpendicular to a surface of the magnetic disk 10. These magnetic disks 10 rotate about a disk axis 10a.

The hard disk apparatus 100 is provided with a magnetic head 20 for writing information to and reading information from front and back surfaces of each of the magnetic disks 10. The magnetic head 20 is held by an arm 30 extending along the front and back surfaces of the magnetic disks 10. The arm 30 rotationally moves around an arm axis 30a so that the magnetic head 20 moves on the magnetic disk 10. The magnetic head 20 corresponds to an example of the pattern reading section of the information generation apparatus.

A control circuit 40 controls the magnetic head 20 to read and write information, and controls the arm 30 to move. Information is exchanged with the host apparatus via this control circuit 40.

Control information (servo information) needed for controlling the magnetic head 20 to read and write information and controlling the arm 30 to move is previously written on the magnetic disk 10 as a magnetic pattern when the magnetic disk 10 is manufactured. This magnetic pattern representing the control information is hereinafter referred to as a servo pattern. It should be noted that not all of the servo pattern is previously written at the time of manufacturing. In the servo pattern, a later-described portion representing a correction signal is written with the magnetic head 20 when the hard disk apparatus 100 is used.

Data (user data), which a user of the hard disk apparatus 100 inputs to the hard disk apparatus 100, is written on the magnetic disk 10 as a magnetic pattern. The magnetic head 20 writes the user data according to a control based on the servo information represented by the servo pattern. The magnetic pattern representing the user data is hereinafter referred to as a user data pattern.

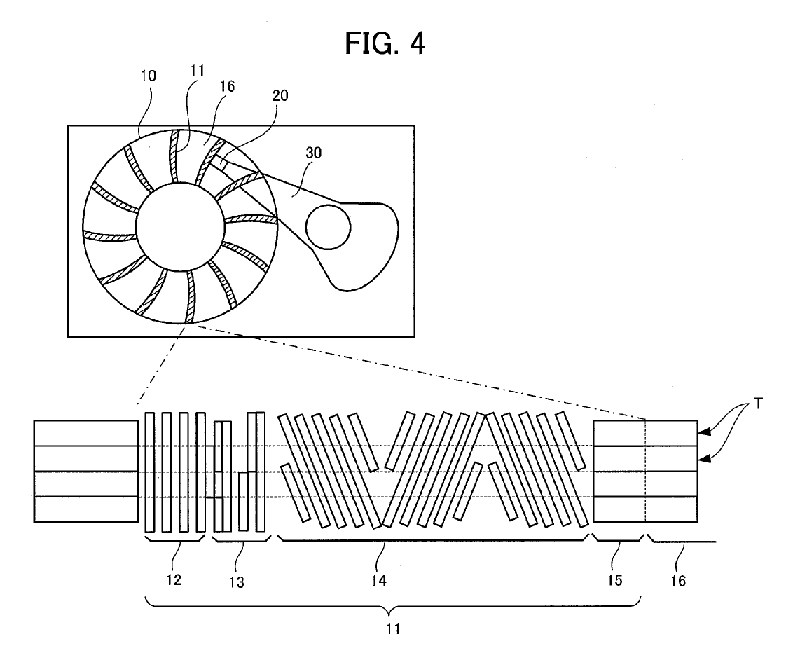

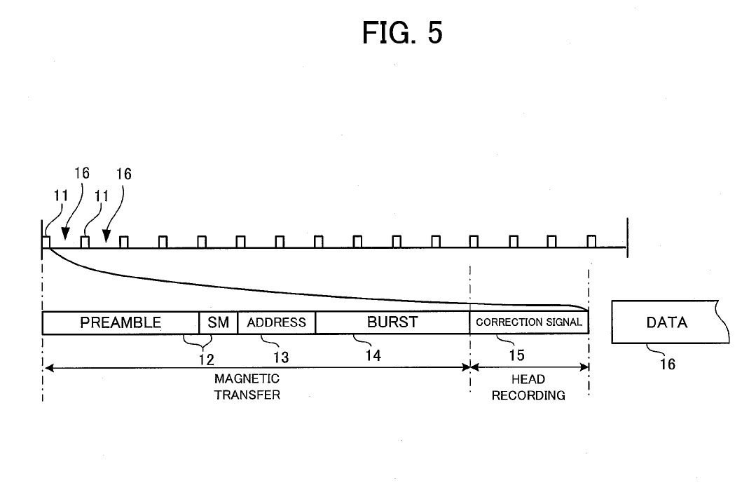

FIG. 4 is a figure illustrating the servo pattern on the magnetic disk 10. FIG. 5 is a figure illustrating the control information represented by the servo pattern.

As illustrated in an upper row of FIG. 4, a servo pattern 11 is recorded on the magnetic disk 10 in an arc-shaped area extending along the circular arc movement of the magnetic head 20 caused by the pivoting of the arm 30. The servo patterns 11 are recorded at multiple locations (twelve locations in FIG. 4) on the magnetic disk 10.

An example of a shape of a magnetic pattern forming the servo pattern 11 is illustrated in a lower row of FIG. 4. Herein, four sets of tracks T are illustrated as an example. It should be noted that in the servo pattern 11, FIG. 4 illustrates shapes of the magnetic patterns of portions 12, 13, 14 previously recorded on the magnetic disk 10 with the magnetic transfer method at the time of manufacturing. FIG. 4 does not illustrate a shape of a portion 15 but illustrates only a position of the portion 15 written with the magnetic head 20 at the time of actual use because the portion 15 varies depending on usage situations.

On the magnetic disk 10, there exist many tracks T in a concentric pattern whose common center is the center of the magnetic disk 10. Data are recorded in a direction along these tracks T (a so-called circumferential direction). However, there does not exist any special physical structure at a position of each track T. The positions of the tracks T are determined by recording the servo patterns 11 on the magnetic disk 10.

As illustrated by FIG. 4 and FIG. 5, the servo pattern 11 has the portion 12 having a preamble and a servo mark written thereon, the portion 13 having an address written thereon, the portion 14 having a burst written thereon, and the portion 15 having a correction signal written thereon. Behind the portion 15 for the correction signal, a user data area 16 follows, to which a user writes arbitrary user data.

The preamble serves as a reference signal for generating a self-clock indicating a timing for reading data. The servo mark represents a starting position of the servo data. The address is information for distinguishing the tracks from one another. The burst is a pattern for detecting a positional offset between the track and the magnetic head. The correction signal is a signal used for correcting a signal when user's data are read out.

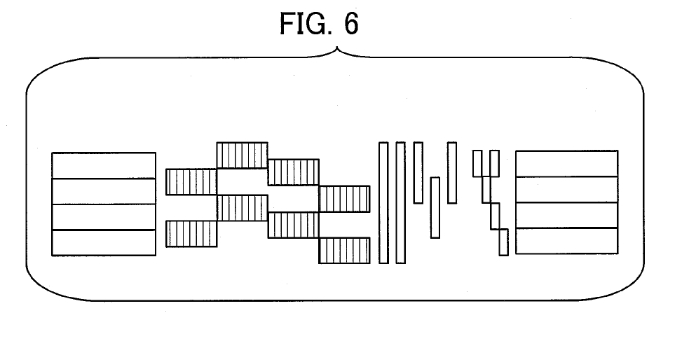

Other than a shape illustrated as an example in FIG. 4, a so-called staggered pattern as illustrated in FIG. 6 is known as a shape of the magnetic pattern for recording a content of information as illustrated in FIG. 5.

As hereinabove described, the magnetic pattern as illustrated in FIG. 4 is written on the magnetic disk with the magnetic transfer method. In the magnetic transfer, the magnetic transfer master is used that has the concave-convex pattern having the same shape as a shape of the magnetic pattern to be written.

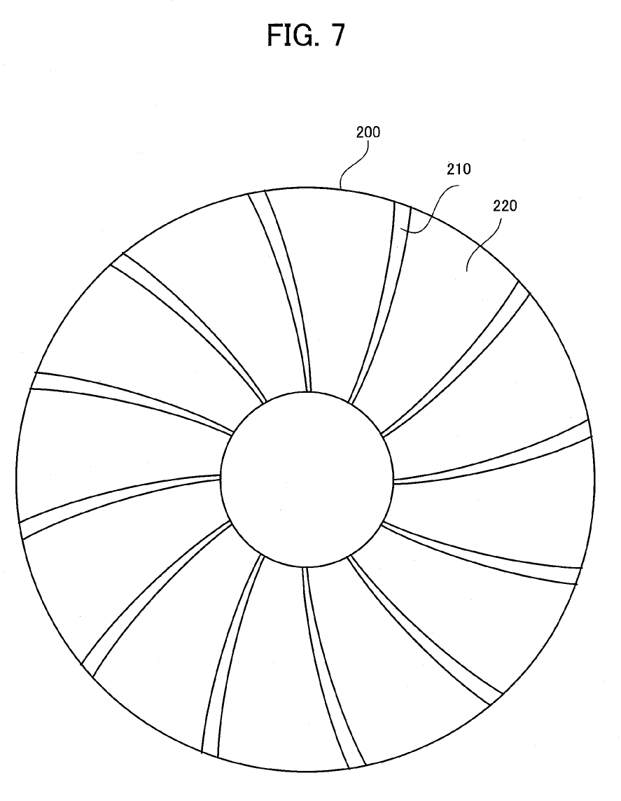

FIG. 7 is an overall view of the magnetic transfer master used for the magnetic transfer.

A magnetic transfer master 200 as illustrated in FIG. 7 is the first specific embodiment of the magnetic transfer master. The magnetic transfer master 200 has the same size as the magnetic disk 10. On the magnetic transfer master 200, there exist a pattern formation area 210 corresponding to the area of the servo pattern and a pattern non-formed area 220 corresponding to the user data area. The shape of the pattern formation area 210 is in mirror image relationship to a shape of the area of the servo pattern 11 as illustrated in FIG. 4.

On the magnetic transfer master 200, the servo information to be recorded on the magnetic disk 10 is represented by the concave-convex pattern. The servo information is represented by bit values. One of the bit value (for example, a value “0”) corresponds to one of convex and concave (for example, a concave portion). The other of the bit value (for example, a value “1”) corresponds to the other of convex and concave (for example, a convex portion).

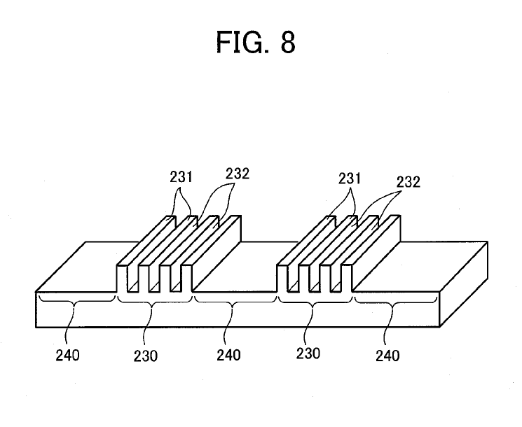

FIG. 8 is an enlarged view of the concave-convex pattern formed in the pattern formation area 210 on the magnetic transfer master.

As hereinabove described, there exist convex portions 230 and concave portions 240 in the concave-convex pattern formed on the magnetic transfer master. A lateral direction of FIG. 8 corresponds to a direction in which the tracks extend on the magnetic disk. The concave-convex pattern on the magnetic transfer master has a pattern in which the convex portions 230 and the concave portions 240 are lined up alternately along the tracks. The convex portions 230 and the concave portions 240 as illustrated in FIG. 8 have a length corresponding to the shortest pattern length in the concave-convex pattern. However, in the actual concave-convex pattern, the convex portion 230 and the concave portion 240 have lengths according to information, and a planar shape of the convex portions 230 and the concave portions 240 on the surface of the magnetic transfer master is in mirror image relationship to the shape of the magnetic pattern as illustrated in FIG. 4. The pattern of the convex portions 230 and the concave portions 240 as described above corresponds to an example of the concave-convex pattern on the magnetic transfer master.

As illustrated in FIG. 8, the convex portion 230 of the concave-convex pattern is further divided into multiple projecting threads 231. An interval between the projecting threads 231 is shorter than the shortest pattern length regardless of a length of the convex portion 230. Thus, a pattern made of these projecting threads 231 and grooves 232 between the projecting threads 231 does not represent information. Each projecting thread 231 and each groove 232 extend in a direction intersecting the tracks on the magnetic disk. Herein especially, it is a direction toward the center of the magnetic disk and the magnetic transfer master (a so-called radius direction). The projecting thread 231 as described above corresponds to an example of the projecting thread on the magnetic transfer master.

The concave-convex pattern of the magnetic transfer master is transferred onto the magnetic disk as the magnetic pattern.

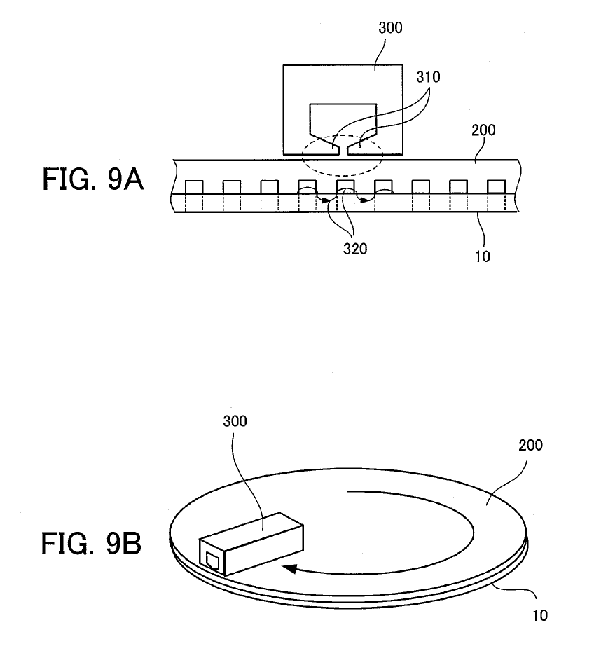

FIGS. 9A and 9B are explanatory diagrams for illustrating the magnetic transfer method for transferring the concave-convex pattern of the magnetic transfer master onto the magnetic disk.

In the magnetic transfer method, as illustrated in FIG. 9A, the magnetic transfer master 200 is first placed on the magnetic disk 10 to which data has not yet been written, so that the convex portions of the concave-convex pattern formed on the surface of the magnetic transfer master 200 come in contact with the surface of the magnetic disk 10. A step as illustrated in FIG. 9A corresponds to an example of the arrangement step in the magnetic transfer method.

Then, a magnet 300 is placed on the magnetic transfer master 200. The magnet 300 has two magnetic poles 310 lined up on the magnetic transfer master 200, so that a magnetic field is formed between these magnetic poles 310. The magnetic field is in a direction along the surface of the magnetic transfer master 200 and the magnetic disk 10. The magnetic field in the direction as described above is applied as the transfer magnetic field. As a result, a magnetic flux 320 of the magnetic field comes and goes between the magnetic transfer master 200 and the magnetic disk 10.

In this arrangement as described above, the magnet 300 is caused to go around along the periphery of the magnetic transfer master 200 and the magnetic disk 10 in a disc shape as FIG. 9B illustrates. By causing the magnet 300 to make a round, the transfer magnetic field in a direction along the surface is applied to the entirety of the magnetic transfer master 200 and magnetic disk 10. The step as illustrated in FIG. 9B corresponds to an example of the application step in the magnetic transfer method.

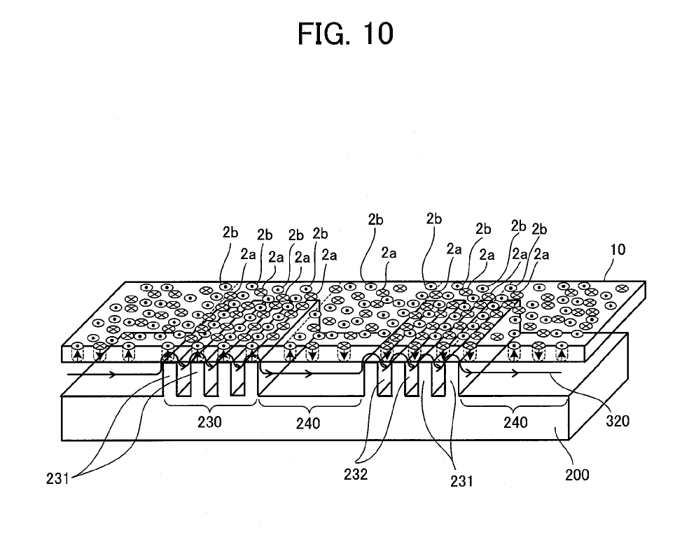

FIG. 10 is a figure illustrating the magnetization formed on the magnetic disk 10 by an application of the transfer magnetic field as illustrated in FIGS. 9A and 9B.

The magnetic flux 320 of the transfer magnetic field passes through the magnetic disk 10 at portions where the magnetic transfer master 200 is in contact with the surface of the magnetic disk 10, i.e., at the projecting threads 231 of the convex portions 230. On the other hand, the magnetic flux 320 exits the magnetic disk 10 toward the magnetic transfer master 200 at portions where the magnetic transfer master 200 is away from the surface of the magnetic disk 10, i.e., at the grooves 232 and the concave portions 240. In this way, the magnetic flux 320 comes and goes between the magnetic transfer master 200 and the magnetic disk 10. Thus, the magnetic flux 320 has a component perpendicular to the surface of the magnetic disk 10 (a vertical component) at an edge portion of the magnetic transfer master 200. As described above, the magnetic disk 10 is the vertical magnetic recording medium. Accordingly, the magnetic disk 10 is magnetized by the vertical component. Specifically, at a portion where the magnetic flux 320 enters from the magnetic transfer master 200 to the magnetic disk 10, the magnetization 2b of the magnetic disk 10 is aligned in an upward direction of FIG. 10, whereas at a portion where the magnetic flux 320 returns back from the magnetic disk 10 to the magnetic transfer master 200, the magnetization 2a of the magnetic disk 10 is aligned in a downward direction of FIG. 10. Regardless of strength of the transfer magnetic field, the magnetic flux 320 enters into and exits the magnetic disk 10 at the edge portions of the magnetic transfer master 200. That is, it is precisely at the edge positions that the magnetic flux 320 aligns the magnetizations 2a, 2b. Thus, the precise magnetic pattern is formed on the magnetic disk 10 through the magnetic transfer method as herein illustrated.

The magnetizations of the magnetic disk 10 at positions corresponding to the convex portions 230 of the magnetic transfer master 200 are alternately aligned as the upward magnetization 2b and the downward magnetization 2a. The portions in which the magnetizations 2a, 2b are aligned extend linearly in a direction in which the projecting threads 231 formed on the convex portions 230 extend (namely, the radius direction).

On the other hand, the magnetizations of the magnetic disk 10 at portions corresponding to the concave portions 240 of the magnetic transfer master 200 are temporarily in a direction along the magnetic flux 320 while the transfer magnetic field exists because the magnetic flux 320 is in a direction along the surface of the magnetic disk 10. However, when the transfer magnetic field disappears, the magnetizations of the magnetic disk 10 at portions corresponding to the concave portions 240 of the magnetic transfer master 200 become a random mixture of the upward magnetization 2b and the downward magnetization 2a so that the energy of the magnetization becomes the smallest.

The magnetic head reads the magnetic pattern of the magnetic disk 10 having become in a state of the magnetization as described above.

The magnetic head moves along the tracks on the magnetic disk 10 in a so-called circular direction (a lateral direction of FIG. 10), and generates a read signal according to directions of the magnetizations of the magnetic disk 10. Regarding the dimension of a core of the magnetic head, a core width perpendicular to a travelling direction of the magnetic head is larger than a core length along the travelling direction. The core width is in the radius direction of the magnetic disk 10.

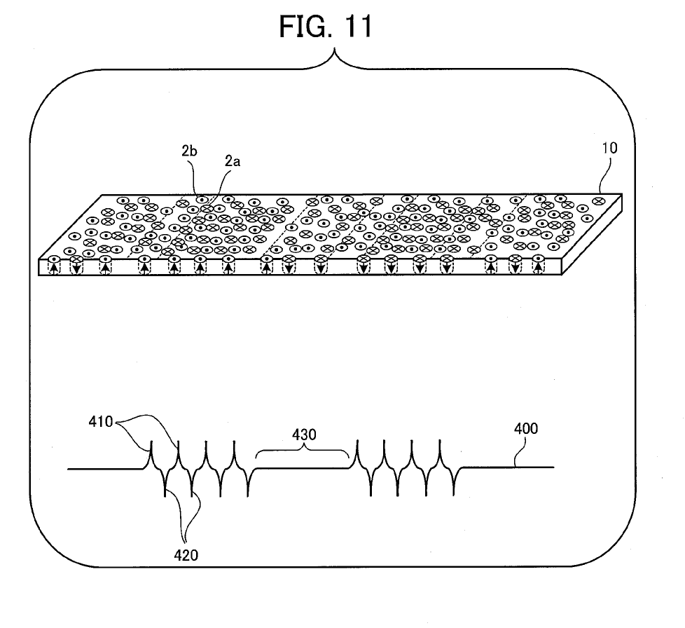

FIG. 11 is a figure illustrating the read signal obtained by causing the magnetic head to read the magnetic pattern of the magnetic disk 10.

An upper row of FIG. 11 illustrates the magnetic disk 10 magnetized as illustrated in FIG. 10. A lower row of FIG. 11 illustrates a read signal 400 obtained by reading the magnetic pattern from this magnetic disk 10.

The core of the magnetic head generates the read signal according to the magnetizations 2a, 2b of the magnetic disk 10 while moving in a lateral direction of FIG. 11. Thus, plus signal peaks 410 are generated at portions where the magnetizations 2b in an upward direction of FIG. 11 are lined up in the radius direction, whereas minus signal peaks 420 are generated at portions where the magnetizations 2a in a downward direction of FIG. 11 are lined up in the radius direction. Flat signal portions 430 producing neither plus nor minus signal value are generated at portions where the magnetizations 2a, 2b are randomly mixed up because the magnetizations 2a, 2b in an area corresponding to the core width of the magnetic head are averaged.

In the read signal 400 as described above, the flat signal portion 430 represents one of the bit value (for example, a value “0”), whereas a portion in which the plus and minus signal peaks 410, 420 are alternately lined up represents the other of the bit value (for example, a value “1”).

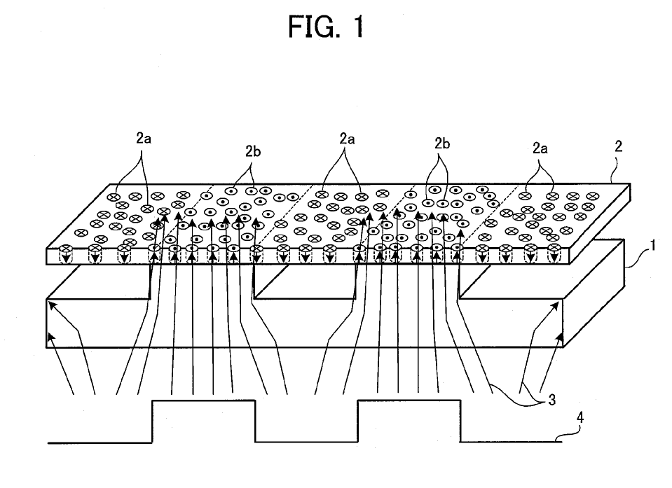

Compared with the read signal 400 obtained from the magnetic pattern written with the magnetic transfer as illustrated in FIG. 11, a read signal written to the magnetic disk 10 with the magnetic head and read out from the magnetic disk 10 with the magnetic head has a rectangular waveform very much similar to the read signal 4 as illustrated in FIG. 1. Both of the read signals are inputted to the control circuit 40 as illustrated in FIG. 3 and are processed, so that information is reproduced.

A reproduction processing circuit in the control circuit will be hereinafter described.

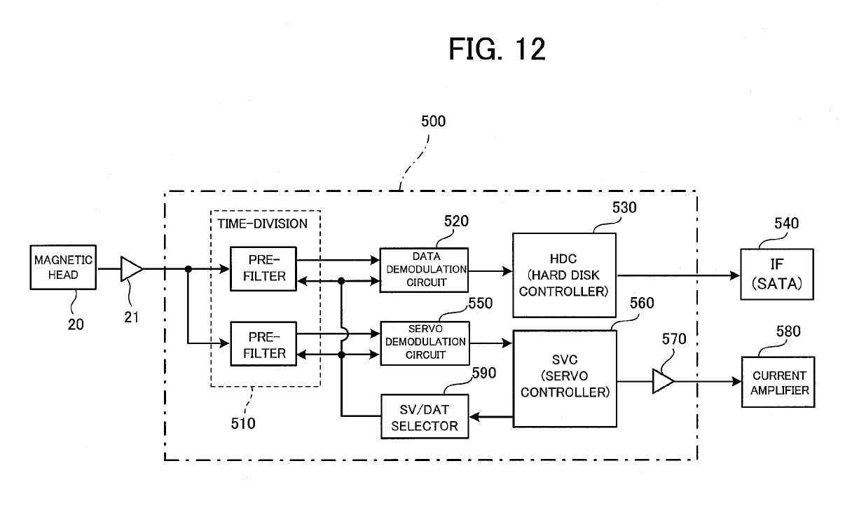

FIG. 12 is a functional block diagram of the reproduction processing circuit in the control circuit.

The magnetic head 20 reads the magnetic pattern to obtain the read signal, and the obtained read signal is amplified by a preamplifier 21 and is inputted to a reproduction processing circuit 500. The read signal inputted to the reproduction processing circuit 500 is first taken into a prefilter 510. Although two functional blocks are illustrated as the prefilter 510 in FIG. 12, the two functional blocks schematically illustrate filters defined by two configurations switched according to time-division. The two functional blocks are actually achieved with one circuit. The configuration of the prefilter 510 is switched according to whether the read signal is a servo signal derived from the servo pattern or a data signal derived from the magnetic pattern.

In a case of the data signal, the read signal is sent to a data demodulation circuit 520 to be demodulated into user data, and the user data is outputted to an interface 540 via an HDC (hard disk controller) 530.

On the other hand, in a case of the servo signal, the read signal is sent to a servo demodulation circuit 550 to be demodulated into servo information, and an SVC (servo controller) 560 generates a control signal based on the servo information. The control signal is inputted to a current amplifier 580 via a DA converter 570. Thus, an electric current flows into a head actuator and the like, so that a positional control of the magnetic head is performed.

The servo controller 560 keeps track of when the data signal and the servo signal are switched. When the data signal and the servo signal are switched, the servo controller 560 changes the configuration of the prefilter 510 via a servo data selector 590.

Circuits subsequent to the prefilter 510 in this reproduction processing circuit 500 correspond to an example of the information reproduction section in the information generation apparatus.

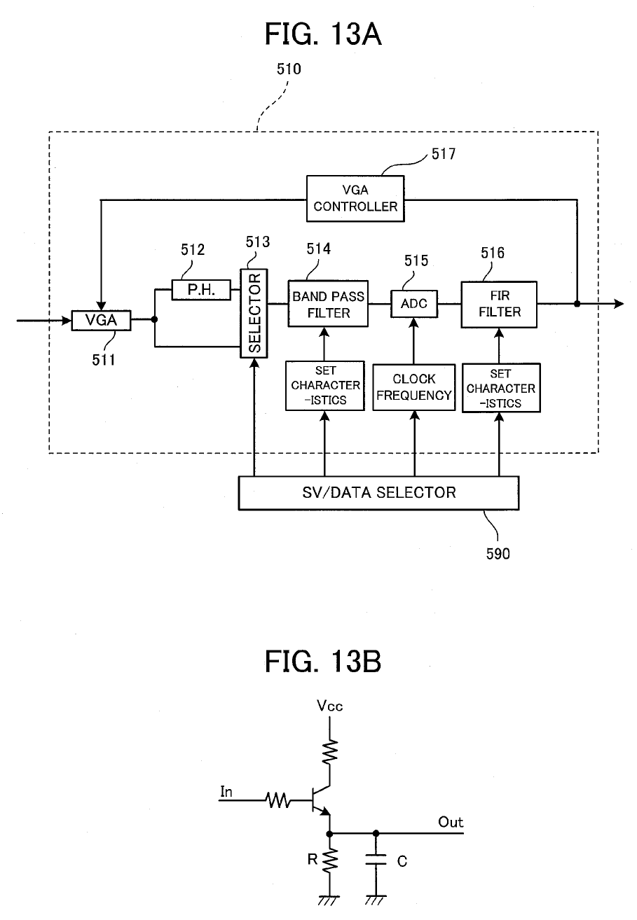

FIGS. 13A and 13B are figures illustrating the prefilter.

FIG. 13A illustrates the prefilter 510. FIG. 13B illustrates a peak hold circuit 512 incorporated into the prefilter 510. The peak hold circuit 512 as herein illustrated corresponds to an example of the peak hold section in the information reproduction apparatus.

The signal from the preamplifier 21 enters into a VGA (Variable Gain Amp) 511, and the signal from the VGA 511 is inputted into a selector 513 via the peak hold circuit 512. Signals not going through the peak hold circuit 512 are directly inputted to the selector 513 from the VGA 511.

The selector 513 is switched by a signal from the servo data selector 590. In a case of the servo signal, the signal going through the peak hold circuit 512 is selected. In a case of the data signal, the signal directly coming from the VGA 511 is selected.

In this way, the signal selected by the selector 513 passes through an analog band pass filter 514 whose filter configuration value is set by the signal from the servo data selector 590, and is converted into a digital signal by an AD converter 515. The AD converter 515 performs sampling at a clock whose frequency is selected according the signal from the servo data selector 590. The digital signal converted by the AD converter 515 is outputted upon passing through an FIR filter 516 whose characteristics are set according to the signal from the servo data selector 590. The signal from the FIR filter 516 is inputted into a VGA controller to be used for a gain adjustment of the VGA 511.

The peak hold circuit 512 has a circuit configuration as illustrated in FIG. 13B. When the signal rises, in response to an input waveform In to a transistor, a current larger by a current amplification factor of β is provided from a power source Vcc to quickly provide a capacitor C with a sufficient charge, so that an output waveform Out rises at the same time as the input waveform In. On the other hand, when the signal falls, a value iβ through the transistor becomes small (approximately equal to off), and the charge in the capacitor C is slowly discharged via a resistor R, so that a peak of the signal is held according to a time constant determined by a combination of the capacitor C and the register R.

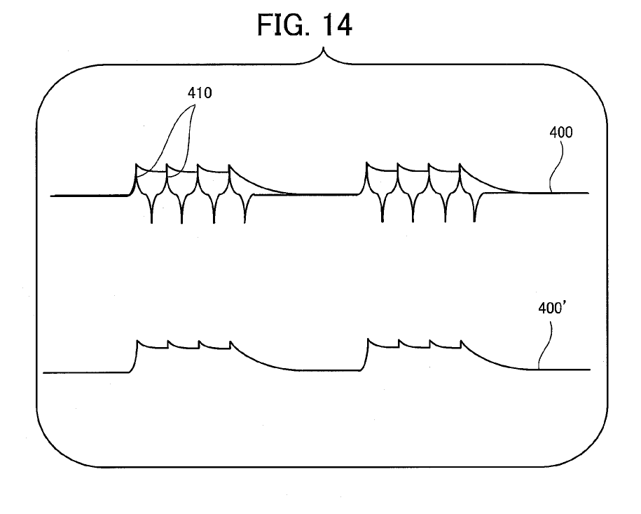

FIG. 14 is a figure illustrating a transformation of the signal waveform by the peak hold circuit.

When the read signal 400 having a waveform as illustrated in FIG. 11 passes through the peak hold circuit, a peak 410 of the read signal 400 is held as illustrated in an upper row of this FIG. 14, and becomes a signal waveform 400′ as illustrated in a lower row of this FIG. 14. The signal waveform 400′ can be subjected to a signal processing as a rectangular waveform. Thus, only the read signal obtained from the servo pattern recorded with the magnetic transfer is caused to pass through the peak hold circuit, and the read signal in the rectangular waveform obtained from the magnetic pattern recorded with the magnetic head is caused to divert around the peak hold circuit, so that information recorded with either of the magnetic transfer and the magnetic head can be reproduced in the same manner with a conventionally-known processing circuit for processing a signal in a rectangular waveform.

As described above, the magnetic pattern formed with the magnetic transfer as illustrated in FIGS. 9A, 9B and FIG. 10 using the magnetic transfer master having a structure as illustrated in FIG. 8 is compatible with the magnetic pattern written with the magnetic head. Accordingly, a single system is sufficient for the reproduction processing circuit (a read channel).

A manufacturing method for the magnetic transfer master having a structure as illustrated in FIG. 8 will be hereinafter described.

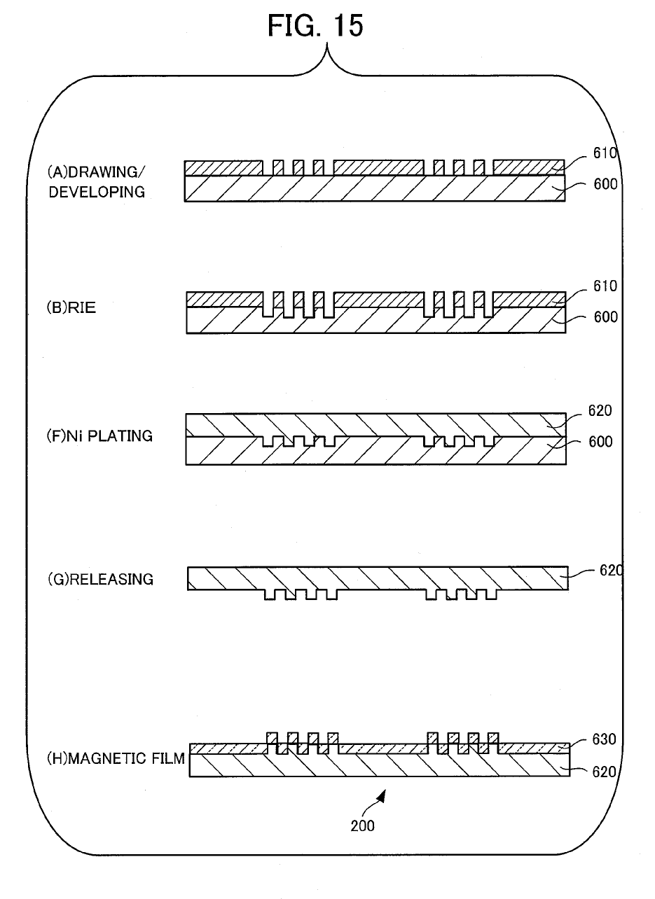

FIG. 15 is a figure illustrating a manufacturing method for the magnetic transfer master.

In FIG. 15, the manufacturing method corresponding to the first specific embodiment of the master production method is illustrated in five steps (A), (B), (F), (G), and (H).

In this manufacturing method, a drawing and developing step (A) is first performed. In the drawing and developing step (A), an electron beam resist 610 (ZEP-520 made by ZEON CORPORATION) is applied onto a silicon wafer 600 having a diameter of 6 inches, which is to be a substrate, in a similar manner as a manufacturing step for a stamper for an optical disk. Then, a shape corresponding to the servo pattern 11 as illustrated in FIG. 4 including the projecting threads 231 and the grooves 232 as illustrated in FIG. 8 is drawn and developed on the silicon wafer 600 by an electron beam lithography apparatus.

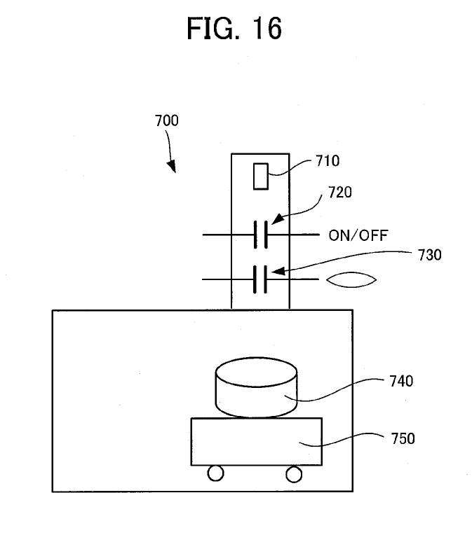

FIG. 16 is a figure describing an electron beam lithography apparatus.

An electron beam lithography apparatus 700 has an electron beam gun 710 for emitting an electron beam, a first electrode 720 for controlling turning on and off the electron beam, a second electrode 730 for exerting an effect on the electron beam similarly to a lens to control convergence and diffusion of the electron beam, a rotation stage 740 for mounting and rotating a silicon wafer substrate, and a linear stage 750 for moving the silicon wafer substrate together with the rotation stage 740 in left and right directions of FIG. 16.

In the drawing and developing step, the second electrode 730 narrows the electron beam, and the movement of the rotation stage 740 and the linear stage 750 causes the silicon wafer to rotate and move so that the electron beam traces each track one by one. The first electrode 720 controls turning on and off the electron beam according to a concave-convex shape of the magnetic transfer master including the projecting thread 231 and the groove 232 as illustrated in FIG. 8.

Referring back to FIG. 15, the description is further continued.

When the electron beam resist 610 having a shape according to the concave-convex shape of the magnetic transfer master is formed in the drawing and developing step (A) of FIG. 15, an RIE (Reactive Ion Etching) step (B) is subsequently performed. In the RIE step (B), an RIE is performed using an SF₆ gas reactive with silicon, so that grooves having a depth 100 nm are formed at portions of the silicon wafer 600 that are not covered by the electron beam resist 610. Thereafter, the electron beam resist 610 is removed by ashing using oxygen gas. It should be noted that the RIE condition is that the amount of SF₆ gas is 15 cc/min under 1 Pa and the RIE is performed for 60 seconds. The ashing condition is that the amount of oxygen is 100 cc/min under 10 Pa and the ashing is performed for 3 minutes. As a result of this RIE step (B), the silicon wafer 600 becomes a mold.

Subsequently, in an Ni plating step (F), an Ni plating layer 620 having a thickness 0.3 mm is formed on this mold of the silicon wafer 600. In a releasing step (G), the plating layer 620 is released. Finally, in a magnetic film formation step (H), an FeCo film 630 having a thickness 100 nm is formed on the Ni plating layer 620 by sputtering. Thus, the magnetic transfer master 200 is completed.

The magnetic transfer master can be manufactured with the manufacturing method as described above. However, as the structure and the manufacturing method of the magnetic transfer master, it is possible to employ structures and manufacturing methods other than the structure as illustrated in FIG. 8 and the manufacturing method as illustrated in FIG. 15. Embodiments other than the first embodiment as described above will be hereinafter described.

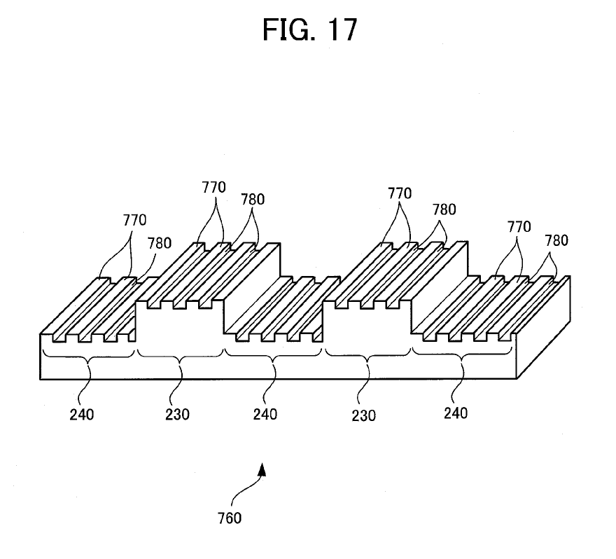

FIG. 17 is a figure illustrating a structure of a magnetic transfer master according to the second embodiment.

A magnetic transfer master 760 according to the second embodiment is formed with the convex portion 230 and the concave portion 240 similarly to the first embodiment. The planar shape (the concave-convex pattern) of the convex portions 230 and the concave portions 240 is the same as the planar shape (the concave-convex pattern) of the first embodiment, and is in mirror image relationship to the shape of the magnetic pattern as illustrated in FIG. 4.

On the other hand, the magnetic transfer master 760 according to the second embodiment is different from the first embodiment in that the projecting threads 770 and the grooves 780 are formed on both of the convex portions 230 and the concave portions 240 and that the depth of the groove 780 is less than the height of the convex portion 230. In this way, the projecting threads 770 and the grooves 780 are formed on the concave portion 240 of the second embodiment; however, the projecting threads 770 and the grooves 780 formed on the concave portion 240 does not exert any effect on the magnetic flux during the magnetic transfer, and the magnetic pattern formed with the magnetic transfer is exactly the same between the first embodiment and the second embodiment. The projecting thread 770 corresponds to the projecting thread of the magnetic transfer master.

Subsequently, a manufacturing method for the magnetic transfer master 760 according to the second embodiment will be hereinafter described.

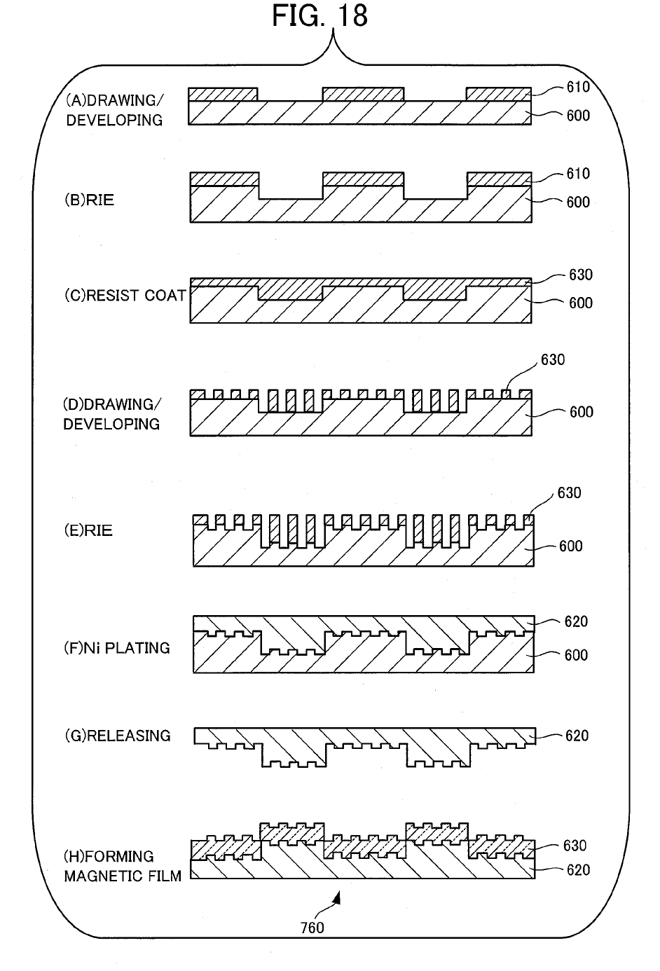

FIG. 18 is a figure illustrating the manufacturing method of the magnetic transfer master according to the second embodiment.

In FIG. 18, the manufacturing method for manufacturing the magnetic transfer master according to the second embodiment is illustrated in eight steps (A), (B), (C), (D), (E), (F), (G), and (H).

In this manufacturing method according to the second embodiment, the drawing and developing step (A) is first performed. In the drawing and developing step (A), the electron beam resist 610 (ZEP-520 made by ZEON CORPORATION) is applied onto the silicon wafer 600 having the diameter of 6 inches, which is to be the substrate. Then, the electron beam lithography apparatus draws and develops on the silicon wafer 600 a shape corresponding to the servo pattern 11 as illustrated in FIG. 4 with respect to only the concave-convex pattern of the convex portions 230 and the concave portions 240 as illustrated in FIG. 17. That is, a shape of the projecting threads 770 and the grooves 780 as illustrated in FIG. 17 is not drawn in the drawing and developing step (A). The drawing and developing step (A) according to the second embodiment corresponds to an example of the pattern formation step of the master manufacturing method.

Subsequently, in the RIE step (B), the RIE is performed using the SF₆ gas reactive with silicon, so that the groove having the depth 100 nm is formed at portions of the silicon wafer 600 that are not covered by the electron beam resist 610. Thereafter, the electron beam resist 610 is removed by ashing using oxygen gas.

Subsequently, in a resist coat step (C), an electron beam resist 630 (ZEP-520 made by ZEON CORPORATION) is again applied to all over the silicon wafer 600.

Subsequently, in a second drawing and developing step (D), a shape of the projecting threads 770 and the grooves 780 as illustrated in FIG. 17 is drawn and developed on all over the electron beam resist 630. The second drawing and developing step (D) corresponds to an example of the projecting thread dividing step in the master manufacturing method. The electron beam lithography apparatus 700 as illustrated in FIG. 16 and a later-described stencil mask are used in the second drawing and developing step (D).

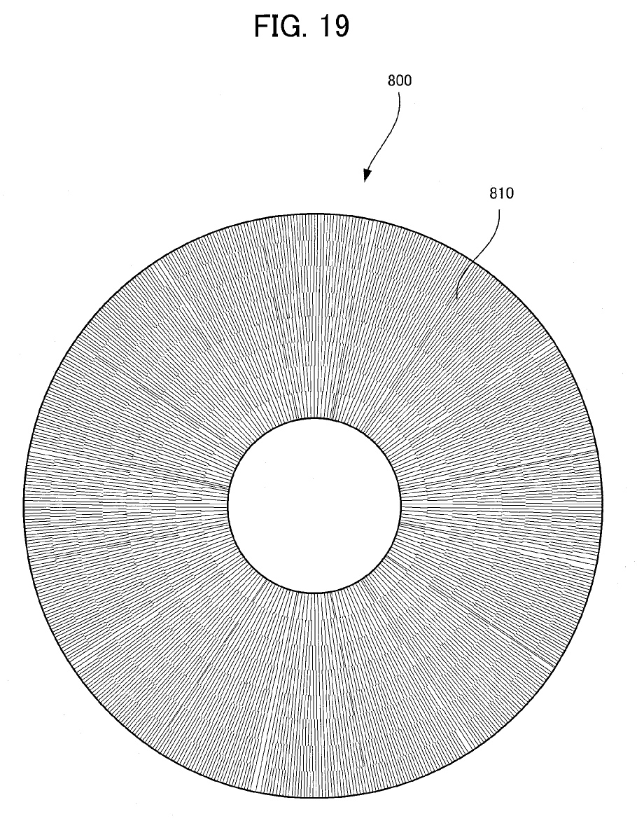

FIG. 19 is a figure illustrating the stencil mask.

The size of a stencil mask 800 is the same as the silicon wafer. On all over the stencil mask 800, many grooves 810 are evenly formed, and the grooves 810 have the same width and the same interval as a width and an interval of the projecting threads 770 as illustrated in FIG. 17. These grooves 810 extend in directions toward the center of the stencil mask 800 (namely, radius directions). The stencil mask 800 as illustrated in FIG. 19 corresponds to an example of the stencil mask in the master manufacturing method.

In the second drawing and developing step (D) as illustrated in FIG. 18, the silicon wafer 600 is placed on the rotation stage 740 of the electron beam lithography apparatus 700 as illustrated in FIG. 16, and the stencil mask 800 as illustrated in FIG. 19 is placed on the electron beam resist 610 on the silicon wafer 600. Then, the second electrode 730 of the electron beam lithography apparatus 700 diffuses an electron beam, and the electron beam is emitted onto all over the stencil mask 800 and the silicon wafer 600 at one time. As a result, the electron beam is emitted to the electron beam resist 630 only in portions of the grooves 810 of the stencil mask 800.

The drawing and developing step using the stencil mask 800 as described above can achieve more highly precise drawing than in a case where drawing is performed with the electron beam lithography apparatus turning on and off the electron beam, and is thus suitable for forming the projecting threads 770 and the grooves 780 having a narrow interval as illustrated in FIG. 17. Furthermore, the stencil mask 800 only for forming the pattern of the projecting threads 770 as described above can also be used to make another magnetic transfer master of a different data pattern. Thus, a high versatility is achieved in instruments for manufacturing the magnetic transfer master.

Referring back to FIG. 18, the description is further continued.

When the shape of the projecting threads 770 and the grooves 780 as illustrated in FIG. 17 is drawn on the electron beam resist 630 in the second drawing and developing step (D), a second RIE step (E) is subsequently performed. In the second RIE step (E), the RIE is performed using the SF₆ gas reactive with silicon, so that grooves having a depth 20 nm are formed at portions of the silicon wafer 600 that are not covered by the electron beam resist 630. Thereafter, the electron beam resist 630 is removed by ashing using oxygen gas. As a result of this second RIE step (E), the silicon wafer 600 becomes a mold.

Subsequently, in an Ni plating step (F), an Ni plating layer 620 having a thickness 0.3 mm is formed on this mold of the silicon wafer 600. In a releasing step (G), the plating layer 620 is released. Finally, in a magnetic film formation step (H), an FeCo film 630 having a thickness 100 nm is formed on the Ni plating layer 620 by sputtering. Thus, the magnetic transfer master 760 according to the second embodiment is completed.

Subsequently, the third embodiment will be described.

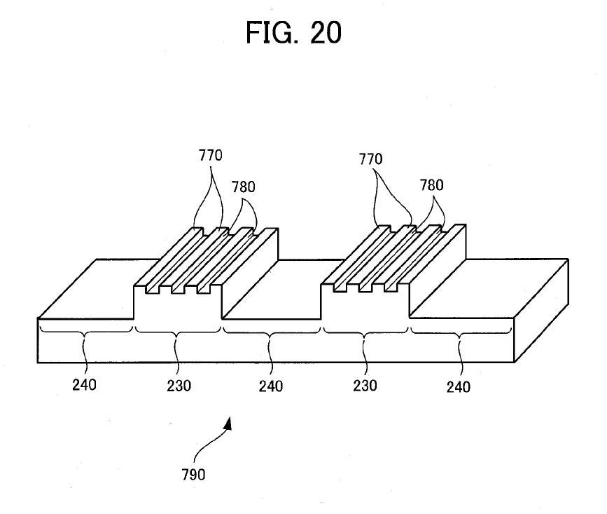

FIG. 20 is a figure illustrating a structure of a magnetic transfer master according to the third embodiment.

A magnetic transfer master 790 according to the third embodiment is formed with the convex portion 230 and the concave portion 240 similarly to the first and second embodiments. The planar shape (the concave-convex pattern) of the convex portions 230 and the concave portions 240 is the same as the planar shape (the concave-convex pattern) of the first and second embodiments, and is in mirror image relationship to the shape of the magnetic pattern as illustrated in FIG. 4.

On the other hand, similarly to the first embodiment, the magnetic transfer master 790 according to the third embodiment has the projecting threads 770 and the grooves 780 formed on the convex portions 230 and does not have the projecting threads and the grooves formed on the concave portions 240. The depth of the groove 780 is less than the height of the convex portion 230, similarly to the second embodiment. The projecting thread 770 corresponds to the projecting thread of the magnetic transfer master.

Subsequently, a manufacturing method for the magnetic transfer master 790 according to the third embodiment will be hereinafter described.

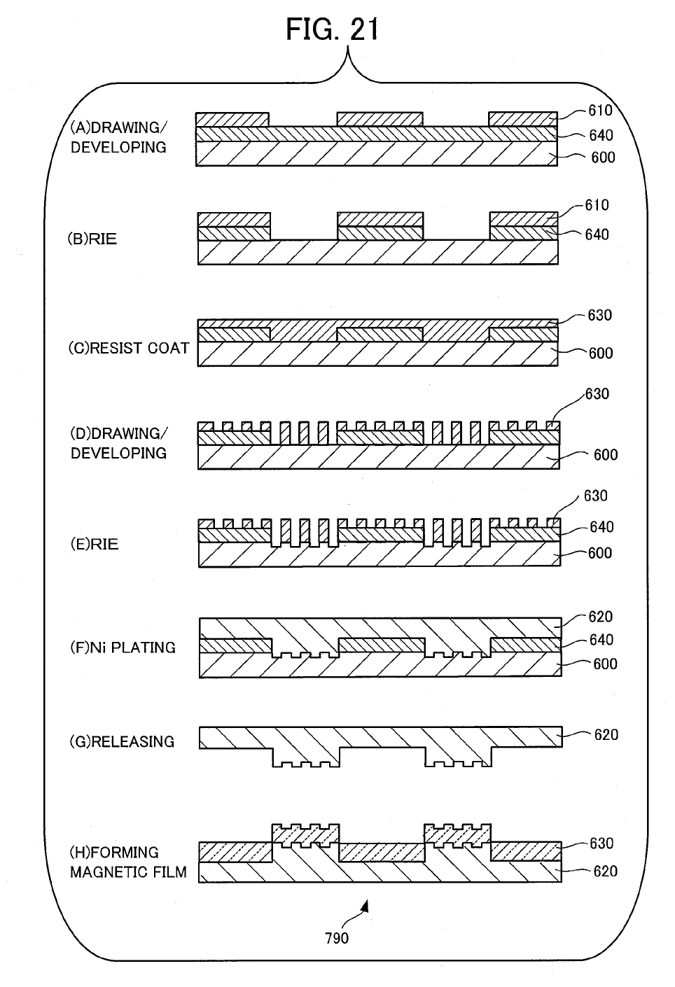

FIG. 21 is a figure illustrating the manufacturing method for the magnetic transfer master according to the third embodiment.

In FIG. 21, the manufacturing method for manufacturing the magnetic transfer master according to the third embodiment is illustrated in eight steps (A) (B), (C), (D), (E), (F), (G), and (H).

In this manufacturing method according to the third embodiment, the drawing and developing step (A) is first performed. In the drawing and developing step (A), the electron beam resist 610 (ZEP-520 made by ZEON CORPORATION) is applied onto the silicon wafer 600, which is to be the substrate, having the diameter of 6 inches and having a thermal oxidation film 640. Then, the electron beam lithography apparatus draws and develops on the silicon wafer 600 a shape corresponding to the servo pattern 11 as illustrated in FIG. 4 with respect to only the concave-convex pattern of the convex portions 230 and the concave portions 240 as illustrated in FIG. 17. That is, a shape of the projecting threads 770 and the grooves 780 as illustrated in FIG. 17 is not drawn in the drawing and developing step (A). The drawing and developing step (A) according to the third embodiment corresponds to an example of the pattern formation step of the master manufacturing method.

Subsequently, in the RIE step (B), the RIE is performed using a mixed gas of CHF₃ and O₂ where CHF₃ is flowed at 20 sccm and O₂ is flowed at 5 sccm, so that the groove having the depth 100 nm is formed at portions of the thermal oxidation film 640 that are not covered by the electron beam resist 610. Thereafter, the electron beam resist 610 is removed by ashing using oxygen gas.

Subsequently, in the resist coat step (C), an electron beam resist 630 (ZEP-520 made by ZEON CORPORATION) is again applied to all over the silicon wafer 600 and the thermal oxidation film 640.

Subsequently, in the second drawing and developing step (D), a shape similar to a shape of the projecting threads 770 and the grooves 780 as illustrated in FIG. 20 is drawn and developed on all over the electron beam resist 630. In the second drawing and developing step (D), the shape of the projecting threads 770 and the grooves 780 are also drawn on portions corresponding to the concave portions 240 as illustrated in FIG. 20. The second drawing and developing step (D) corresponds to an example of the projecting thread dividing step in the master manufacturing method. The electron beam lithography apparatus 700 as illustrated in FIG. 16 and the stencil mask as illustrated in FIG. 19 are used in the second drawing and developing step (D).

Subsequently, in the second RIE step (E), the RIE is performed using the SF₆ gas reactive with silicon, so that grooves having a depth 20 nm are formed at portions of the silicon wafer 600 that are not covered by the electron beam resist 630. At this moment, no grooves are formed on the thermal oxidation film 640 because the thermal oxidation film 640 does not react with the SF₆ gas. Thereafter, the electron beam resist 630 is removed by ashing using oxygen gas. As a result of this second RIE step (E), the silicon wafer 600 and the thermal oxidation film 640 become a mold.

Subsequently, in the Ni plating step (F), the Ni plating layer 620 having a thickness 0.3 mm is formed on the mold of the silicon wafer 600 and the thermal oxidation film 640. In the releasing step (G), the plating layer 620 is released. Finally, in the magnetic film formation step (H), an FeCo film 630 having a thickness 100 nm is formed on the Ni plating layer 620 by sputtering. Thus, the magnetic transfer master 790 according to the third embodiment is completed.

As hereinabove described, several types of detailed structures are conceivable as the magnetic transfer master.

Subsequently, the number of the projecting threads and the grooves formed on the convex portion of the magnetic transfer master will be hereinafter considered. Herein, using the structure according to the third embodiment as illustrated in FIG. 20, several magnetic transfer masters having different numbers of the projecting threads 770 and the grooves 780 were made, and each of the magnetic transfer masters was used to perform the magnetic transfer to record information onto the magnetic disk. Then, each magnetic disk was installed in a hard disk apparatus, and it was confirmed whether the servo information can be demodulated from each magnetic disk using the reproduction processing circuit 500 as illustrated in FIG. 12. The width of the convex portion of the magnetic transfer master was 100 nm corresponding to the shortest pattern length. The number of revolutions of the used hard disk apparatus was 5400 rpm. An average particle diameter of a crystal particle diameter in a magnetic material forming the used magnetic disk was 6 nm.

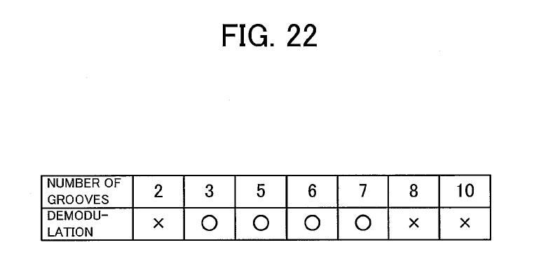

FIG. 22 is a table illustrating whether a demodulation could be achieved depending on the number of the formed grooved.

As FIG. 22 illustrates, in a case where the number of the grooves on the convex portion is 2 (namely, 3 projecting threads), the servo information could not be demodulated. In a case where the number of the grooves on the convex portion is 3 or more (namely, 4 projecting threads or more), the servo information could be demodulated. That is, it is confirmed that the projecting threads are preferred to be arranged at an interval less than one-fourth of the shortest pattern length of the convex-concave pattern.

In a case where the interval between the projecting threads exceeds one-fourth of the shortest pattern length, it is presumed that it becomes difficult for the peak hold circuit to perform processings upon distinguishing between the signal peaks belonging to one convex portion of the convex-concave pattern to be combined into one rectangular waveform and the signal peaks belonging to separate convex portions to be divided into separate rectangular waveforms.

On the other hand, in a case where the number of the grooves on the convex portion is 7 or less (namely, 8 projecting threads or less), the servo information could be demodulated. However, in a case where the number of the grooves on the convex portion is 8 or more (namely, 9 projecting threads or more), it became impossible to demodulate the servo information. It is presumed that this is because the widths of the projecting threads and the grooves became less than the average crystal particle diameter of the magnetic material, so that the interval between the edges became too narrow and an alignment of the magnetization along the edges became broken, thereby raising a problem in transferring the pattern. Thus, it is confirmed that the projecting threads are preferred to have a width equal to or more than the average particle diameter of the crystal particle diameter in the vertical magnetic recording medium and to be arranged at an interval equal to or more than the average particle diameter.

As hereinabove described, according to a magnetic transfer method of the embodiments, a margin for strength of a recording magnetic field is large, and a recorded magnetic pattern has a high degree of compatibility between a magnetic pattern recorded with a magnetic head and a read channel. Also, according to a master manufacturing method according of the embodiments, a magnetic transfer master can be effectively manufactured, and a high ability is provided to deal with multiple types of magnetic transfer masters. Also, according to the information reproduction method, the information reproduction apparatus, and the information storage apparatus of the embodiments, a single system is sufficient for the read channel.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A magnetic transfer method comprising:
arranging a magnetic transfer master so as to cause a surface of the magnetic transfer master to be in proximity to or in contact with a vertical magnetic recording medium, the magnetic transfer master having on the surface thereof a concave-convex pattern representing information, a top surface of a convex portion of the concave-convex pattern being divided by a plurality of projecting threads lined up and extending at an interval shorter than a shortest pattern length of the concave-convex pattern; and
applying a magnetic field to the magnetic transfer master in a direction along the surface and intersecting the projecting threads.

2. The magnetic transfer method according to claim 1, wherein the concave-convex pattern is a pattern in which concaves and convexes are alternately lined up along a predetermined line, and
the projecting thread extends in a direction intersecting the predetermined line.

3. The magnetic transfer method according to claim 1, wherein the projecting threads are lined up at an interval equal to or less than one-fourth of the shortest pattern length of the concave-convex pattern.

4. The magnetic transfer method according to claim 1, wherein the projecting thread has a width equal to or more than an average particle diameter of a crystal particle diameter of the vertical magnetic recording medium, and the projecting threads are lined up at an interval equal to or more than the average particle diameter.

5. A master manufacturing method for manufacturing a magnetic transfer master having on a surface thereof a concave-convex pattern representing information, the magnetic transfer master transferring the information represented by the concave-convex pattern onto a magnetic recording medium as a magnetic pattern by causing the surface to be in proximity to or in contact with the vertical magnetic recording medium with an application of a magnetic field, the master manufacturing method comprising:
forming the concave-convex pattern on a substrate that is to be a basis of the magnetic transfer master; and
before or after the pattern formation, dividing a surface of the substrate into a plurality of projecting threads lined up and extending at an interval shorter than a shortest pattern length of the concave-convex pattern, by forming a plurality of grooves on all over the surface with a stencil mask, the grooves extending in a direction intersecting a direction of the magnetic field.

6. The master manufacturing method according to claim 5, wherein the concave-convex pattern is a pattern in which concaves and convexes are alternately lined up along a predetermined line, and
the projecting thread extends in a direction intersecting the predetermined line.

7. The master manufacturing method according to claim 5, wherein the projecting threads are lined up at an interval equal to or less than one-fourth of the shortest pattern length of the concave-convex pattern.

8. The master manufacturing method according to claim 5, wherein the projecting thread has a width equal to or more than an average particle diameter of a crystal particle diameter of the vertical magnetic recording medium, and the projecting threads are lined up at an interval equal to or more than the average particle diameter.

9. An information reproduction apparatus for reproducing control information and arbitrary information from a vertical magnetic recording medium having the arbitrary information recorded as a magnetic pattern under a control based on the control information, the vertical magnetic recording medium having the control information recorded as the magnetic pattern trough a magnetic transfer method including: arranging a magnetic transfer master so as to cause a surface of the magnetic transfer master to be in proximity to or in contact with the vertical magnetic recording medium, the magnetic transfer master having on the surface thereof a concave-convex pattern representing information, a top surface of a convex portion of the concave-convex pattern being divided by a plurality of projecting threads lined up and extending at an interval shorter than a shortest pattern length of the concave-convex pattern; and applying a magnetic field to the magnetic transfer master in a direction along the surface and intersecting the projecting threads, the information reproduction apparatus comprising:
a pattern reading section that reads the magnetic pattern from the vertical magnetic recording medium to obtain a read signal causing a signal reversal according to a magnetization reversal in the magnetic pattern;
a peak holding section that holds a peak of the read signal obtained from the magnetic pattern of the control information among the read signals obtained by the pattern reading section; and
an information reproduction section that reproduces the control information and the arbitrary information by performing a signal processing on the read signal obtained by the pattern reading section from the magnetic pattern of the arbitrary information and the read signal whose peak is held by the peak holding section, the control information and the arbitrary information being reproduced from the read signals.

10. The information reproduction apparatus according to claim 9, wherein the concave-convex pattern is a pattern in which concaves and convexes are alternately lined up along a predetermined line, and
the projecting thread extends in a direction intersecting the predetermined line.

11. The information reproduction apparatus according to claim 9, wherein the projecting threads are lined up at an interval equal to or less than one-fourth of the shortest pattern length of the concave-convex pattern.

12. The information reproduction apparatus according to claim 9, wherein the projecting thread has a width equal to or more than an average particle diameter of a crystal particle diameter of the vertical magnetic recording medium, and the projecting threads are lined up at an interval equal to or more than the average particle diameter.
